(19) United States
(12) Patent Application Publication
(10) Pub. No.: US 2003/0178136 A1
(43) Pub. Date: Sep. 25, 2003

(54) Method and device for producing a pressurized package

(76) Inventor: Konrad Bohm, Volkertshausen (DE)

Correspondence Address: STEVENS, DAVIS, MILLER & MOSHER, LLP, Suite 850, 1615 L Street N.W., Washington, DC, 20036, US

(21) Appl. No.: 10/367,969

(22) Filed: Feb. 19, 2003

(30) Foreign Application Priority Data
Feb. 20, 2002 (DE) 102 07 129.2

(51) Int. Cl. B32B 31/00

(52) U.S. Cl. 156/293; 156/390; 156/443

(57) ABSTRACT

The invention relates to a method for producing a pressure package comprising the steps:

A) Providing, more particularly producing, a substantially cylindrically pressure package blank (2, 4) including a first diameter (D1) and an open end (12) provided with an aperture (14) and

B) forming the open end (12) to a tapered mouthpiece (22) for sealed closure by a pressure valve by necking and flanging or beading the rim (18, 20) of the aperture (14) of the pressure package blank (2, 4), the diameter of the aperture thereby being reduced from the first diameter (D1) to a smaller diameter (D2).

To ensure a satisfactory sealed closure of the aperture with a dispensing valve, the invention proposes the following step after step B)

C) coating with a coating material (28) the rim (18) surrounding the aperture (14) formed into a bead (24) at a surface area (26) as predefined for sealing mounting the pressure valve.

The invention relates furthermore to a device for implementing this method.

### FIELD OF THE INVENTION

The invention relates to a method for producing a pressurized package as set forth in the preamble of the attached claim 1 as well as to a device for producing a pressurized package as set forth in the preamble of the attached claim 13. Such method and such device are known from WO 99/20413.

### PRIOR ART

Pressurized packages mainly find application as aerosol cans, also termed spray cans. As a rule they are cylindrically shaped and feature a tapered mouthpiece which is closed off by means of a pressure valve or aerosol valve, via which the fill is dispensed. The aperture of the pressurized packages closed off by a pressure valve is usually standardized to a diameter of one inch (25.4 mm). Commercially available are so-called single-chamber pressurized packages consisting of a single outer body totally enclosed, with the exception of the valve aperture, and mostly made of aluminium, as well as so-called two-chamber pressurized packages as producible by the method as set forth in the aforementioned patent WO 99/20413. Two-chamber pressurized packages feature an inner container inserted in an outer container, with a hole at the bottom of the outer container for charging propellant in the space between the inner container and outer container.

To produce single-chamber pressurized packages a substantially cylindrically pressurized package blank is stamped from an aluminium round blank. The pressurized package blank ends cylindrically at the end later forming the mouthpiece. This pressurized package blank is then coated with lacquer inside and out and mostly already provided at this stage with the final packaging lettering and finished packaging design. After this, the open end is necked down into the mouthpiece tapered from the first diameter as determined by the diameter of the pressurized package to that of the standardized valve aperture. In necking, the rim of the valve aperture is turned over, i.e. beaded or flanged. It is for this reason that the pressurized package furnished with the valve aperture still open to the filler, features a flange or bead at the rim of the valve/mouthpiece aperture. The valve is clinch mounted sealed above the flange or bead after the can has been filled.

In a two-chamber pressurized package, an inner container is inserted into the cylindrical blank of the outer container as is described in WO 99/20423. In the two-chamber pressurized package in accordance with WO 99/20423 the inner container is a soft annealed pouch of aluminium which is opened up at the rim of its opening and joined to the rim of the aperture in the outer container by bonding. The rims of the inner container and outer container thus joined together are then necked down into the mouthpiece and flanged or beaded. In this case too, prior to necking and flanging—or to put it more precisely, prior to insertion of the inner container—the outer container blank is already finished coated with varnish, paint, enamel or lacquer, since doing this after flanging would hardly be manageable. It is for the same reason that the inner container too is coated with varnish, lacquer, paint, enamel before necking and flanging. The methods as described above and the correspondingly configured devices for the fabrication or production of pressurized packages have a proven record of success especially with pressurized packages of smaller diameter. Standard high volume fabrication of pressurized packages in accordance with WO 99/20413 makes for no problem with an outer diameter of 40 mm and a 1-inch (25.4 mm) mouth inner diameter.

Problems are encountered, however, when the diameter of the pressurized package exceeds approximately 45 mm. Thus, for an outer diameter of 50 mm of the pressurized package and the standardized valve aperture of 1 inch implementing the known method of fabrication results in, after assembly of the valve, 60 to 70% of the pressurized packages being leaky and thus useless. In general, leakage problems are due to material distortions as occurring in heavy necking down of the mouth or for other reasons such as thicker materials or differences in the properties of the material.

### SUMMARY OF THE INVENTION

In general it is the objective of the invention to provide a method as set forth in the preamble of claim 1 as well as a device in accordance with the preamble of the attached claim 13 with which pressurized packages can now be produced or fabricated in large series production with fewer leakage problems, particularly also when the ratio of the diameter of the pressurized package to that of the valve aperture is larger than usual.

To advantage, the invention has the intention of improving the method as set forth in the preamble of claim 1 as well as a device in accordance with the preamble of the attached claim 13 such that e.g. also pressurized packages of larger outer diameter and a standardized valve aperture diameter or pressurized packages having a smaller valve aperture diameter can now be fabricated in large series production with no leakage problems.

This objective is achieved by a method having the features as set forth in the attached claim 1 and by a device having the features as set forth in attached claim 13 respectively.

Advantageous aspects of the invention are the subject matter of the sub-claims.

The invention thus provides a method for producing a pressurized package comprising the steps of firstly furnishing a pressurized package blank substantially cylindrically in shape having a first diameter—dictating the outer diameter of the pressurized package—and an open end provided with an aperture, i.e. produced more particularly by usual ways and means and then subsequently shaping the open end to a tapered mouthpiece for sealing closure by a pressure valve by necking down and turning over (flanging or beading) the rim of the aperture of the pressurized package blank. Shaping the mouthpiece in this way results in the diameter of the aperture being reduced from a first diameter to a smaller second diameter corresponding more particularly to the standardized 1-inch valve aperture. In accordance with the invention in a last step the rim flanged in the process of shaping the mouthpiece is surface coated with a coating such as varnish, paint, enamel or lacquer intended to sealingly mount the pressure valve.

Tests have shown that it is this subsequent lacquer coating in accordance with the invention that permits achieving a 100% seal in thus avoiding the high rejects due to leakage, as was formerly a problem.

The inventor of the present invention has discovered that with heavy necking down, as is the case with cans of large diameter and standardized valve aperture, irregularities in the form of dimples and cracks materialize in the surface of the flange. This becomes even more of a problem with a two-chamber pressurized package where it is particularly in the rim area for flanging that a composite material is involved. This consists firstly of a hard or relatively hard outer container, then of mostly elastomeric adhesives for joining the outer container and inner container, and thirdly the soft-annealed pouch. These materials distort differingly during flanging or beading so that microcracks and irregulaties materialize in the surface. These cracks are normally only visible in microscopic inspection, although in some cases they may materialize so strongly as to be evident to the naked eye. These microcracks thwart sealing by the rubber gasket inserted as a rule on the pressure valve.

When, however, the portion of the bead or flange is subsequently coated with lacquer, paint, enamel, or varnish, as proposed in accordance with the invention, the coating material flows into these irregularities so that, in all, a smooth surface materializes which is easier to seal.

Although attempts were made in previous trials to smooth out the irregularities and cracks in the surface caused by size reduction from a large diameter to a small diameter solely by milling or rolling, the resulting weakening of the material from such machining is unfavourable to the seal. Apart from this, the protective film applied to the surface prior to reshaping the mouthpiece becomes removed, thus risking corrosion when an aggressive fill is involved. Machining is even more detrimental to two-chamber pressurized packages, since in this case the material is removed at just the location on the weak pouch where it is sealingly joined to the outer container.

Now, however, when the portion needing to be sealed is subsequently coated in accordance with the invention, zero leakage is achievable without the aforementioned problems.

Since pressurized packages are fabricated in a high volume per minute (more than a 100 every minute) this subsequent coating needs to be done very quickly. Apart from this, the coating material itself must not dribble in forming unwanted irregularities. This is achieved in accordance with one advantageous embodiment of the invention in that the bead or flange is coated with a coating material having such a fast curing time and in such a thin film that the applied coating cures in a second or less, preferably in approximately half a second or less.

Particularly fast curing is achieved when the coating material used is an UV coating, i.e. which after being applied to the flange is exposed to ultraviolet radiation. Such UV lacquers or coatings have the special feature of instantly curing when irradiated with UV light. For example, use is made of a lacquer, enamel, varnish or the like coating based on UV cross-linked acrylate resins.

It is furthermore of advantage when use is made of a coating fluid having a particularly low viscosity which quickly finds its way into every crevice on application and wets well with the flange by adhesion. To advantage, in this case, a coating fluid having a viscosity of 15-40 sec, preferably approx. 25 sec is used (viscosity as indicated here being in accordance with German industrial standard DIN 53211 indicating the time required by the lacquer at 20° C. to flow from the DIN beaker of 4 mm). Measuring this flow time with scoops is employed as the standardized test method for determining the viscosity of coating fluids in production and incoming inspection because of its simplicity in handling in practice. The lacquer or the like coating fluid is preferably coated very thin, for example with a film thickness of approximately 1-10 μm and more particularly with a film thickness of 2-3 μm. Coating the lacquer, paint, varnish, enamel or the like may be done by spray, roll, dip, brush application. Preferably, to assist coating, the flange is brought into contact with a material wetted with the coating. The material is preferably elastomeric to ensure a good contact at all locations on the surface to be wetted. Suitable materials are felt, foamed plastics or rubber, preference being given to felt or foamed plastics because of their absorbency. Then, as further preferred, when the material wetted with the coating fluid and the pressurized package contacting therewith are moved relative to each other during contact, this has the advantage that the coating fluid is regularly “kissed” or pushed into the irregularities to be smoothed out. For this purpose, the material wetted with the coating liquid is rotated relative to the flange.

Should unusually large surface irregularities occur it might be of advantage to roughen the surface of the flange by milling prior to applying the coating, which, depending on the circumstances concerned may also, enhance the tack of the coating. By this method even pressurized packages can be reliably sealed whose mouthpiece diameter exceeds 45 mm, for example approx. 50 mm, less the wall thickness of the blank where necessary, is reduced to the standardized 1 inch valve aperture diameter.

The method in accordance with the invention is particularly well suited for two-chamber pressurized packages, the blank of which consists of an outer container and an inner container inserted therein, in producing or fabricating the pressurized package blank, i.e. an inner container inserted in the outer container and joined in the region of the rim of the aperture to the outer container. The method is also particularly well suited for two-chamber pressurized packages in which the inner container and outer container are joined in the region of the flanged rim with an elastomeric adhesive. This is because, then particularly in the region of the flange or bead a material mix of rigid material (outer container), elastomeric material (adhesive) and soft material (soft annealed inner container) exists which tends to form dimples when flanged.

The device in accordance with the invention for producing the pressurized package and for implementing the method in accordance with the invention, just like other devices in use for such purpose, includes a means for supplying the substantially cylindrically blank of the pressurized chamber blank which is provided at its open end with an aperture of still large first diameter, and a necking flanger by means of which the aperture rim of the blank is necked down to the taper mouthpiece with a reduction in the size of the aperture from the first diameter to the standardized smaller diameter and turned over, i.e. flanged. In accordance with the invention a coater for applying the coating material is provided downstream of the necking flanger or tooling of the same, by means of which coating material can be applied to a beaded or flanged rim as formed by the necking flanger.

In one preferred aspect, the device for producing the pressurized package also features a UV lamp for curing an UV curable coating material applied by the coater. Furthermore preferably the coater is provided with an applicator wetted with the coating material for contacting the bead. This applicator is preferably made of absorbent and/or elastomeric material such as felt, foamed plastics or rubber. In one preferred embodiment relative movement means are provided for moving the applicator relative to the bead to be coated with coating material. This is preferably formed by a means for rotating the applicator relative to the pressurized package to be wetted with coating material. In a further preferred aspect the coater includes a coating material feeder controllable by means of a valve, such as, for example, a needle valve for a continuous supply of coating material to the applicator and respectively for replenishing the coating material. Should the producing device and/or the coater be halted for any reason, the coating material feeder is, preferably automatically, shut off to prevent coating material dribble resulting in an irregular film thickness at the coater.

The complete producing device is configured preferably as an automated production system or component thereof with fully automatic control by a controller, so that the individual means of the device, as a whole, are all automatically controlled.

It is particularly preferred that the coater is subsequently provided on a series of tools of the necking flanger as an additional tool thereof. Such tools are as a rule equispaced so that they can successively shape a series of pressurized packages, each of which is forwarded to the next tool. For flanging or beading, the tool holder with the series of tools is movable relative to a holder/feeder means in which the series of pressurized package blanks are held preferably equispaced and advanced from station to station, to bring all tools into contact with each pressurized package blank to be processed all at the same time. Then, with the same movement the coater can be brought into contact with the finished-shaped pressurized package for subsequent coating. Indeed, the UV lamp too, could be included as a further tool in the coater as a further station.

The coater comprises preferably a housing and a coating disk mounted thereon or therein, this coating disk being rotatable relative to the housing by means of a motor, for example, a servomotor. The preferred speed range for the motor is 30 to 300 rpm. The housing is furthermore preferably configured at its ends to face the pressurized package blanks pot-shaped to surround the coating disk rotatable mounted at this location so that the edges of the coating disk are totally enclosed by the housing to thus catch any coating material fling-off from the coating disk. Only a zonal surface area of the coating disk is then accessible for the pressurized package blanks. For this purpose, the end of the housing to face the pressurized package blanks preferably comprises furthermore a conically tapered and thus centring feeder opening, by means of which the mouthpieces to be coated can be located precisely positioned. The feeder opening forms preferably furthermore also a stop for these mouthpieces, so that these come into contact with the coating disk in a precisely defined location in ensuring an even coating. The feeder opening is accommodated, for example, in a housing cover mounted at this end on a housing body removable held on the housing for changing an applicator of absorbent material mounted on the coating disk. The coating disk provided with absorbent material is preferably rotatable on a horizontal rotational axis. Provided in a further preferred aspect above the coating disk, more precisely above the absorbent material on the housing is the coating material feeder which feeds coating material from a dispenser in a precisely dispensed amount to the coating disk. Any coating material dripping from the coating disk and thus superfluous can be discharged in a further preferred aspect by a draining means arranged below the absorbent material.

### BRIEF DESCRIPTION OF THE DRAWINGS

Example aspects of the invention will now be detailed with reference to the attached drawings in which:

FIG. 1 is an illustration of a first embodiment of a cylindrical pressurized package blank;

FIG. 2 is an illustration of a second embodiment of a cylindrical pressurized package blank;

FIG. 3 is an illustration of the mouthpiece location of a pressurized package formed from one of the blanks as shown in FIG. 1 or FIG. 2 by a necking/flanging/beading process for closing off by a valve;

FIG. 4 is an illustration of the mouthpiece location of the pressurized package as shown in FIG. 3 with the bead or flange partially coated with coating material;

FIG. 5 is a section view of a coater for subsequent coating the bead or flange of FIG. 4 with coating material; and

FIG. 6 is a basic illustration of a device for producing pressurized packages in which the coater as shown in FIG. 5 is employed.

### DETAILED DESCRIPTION

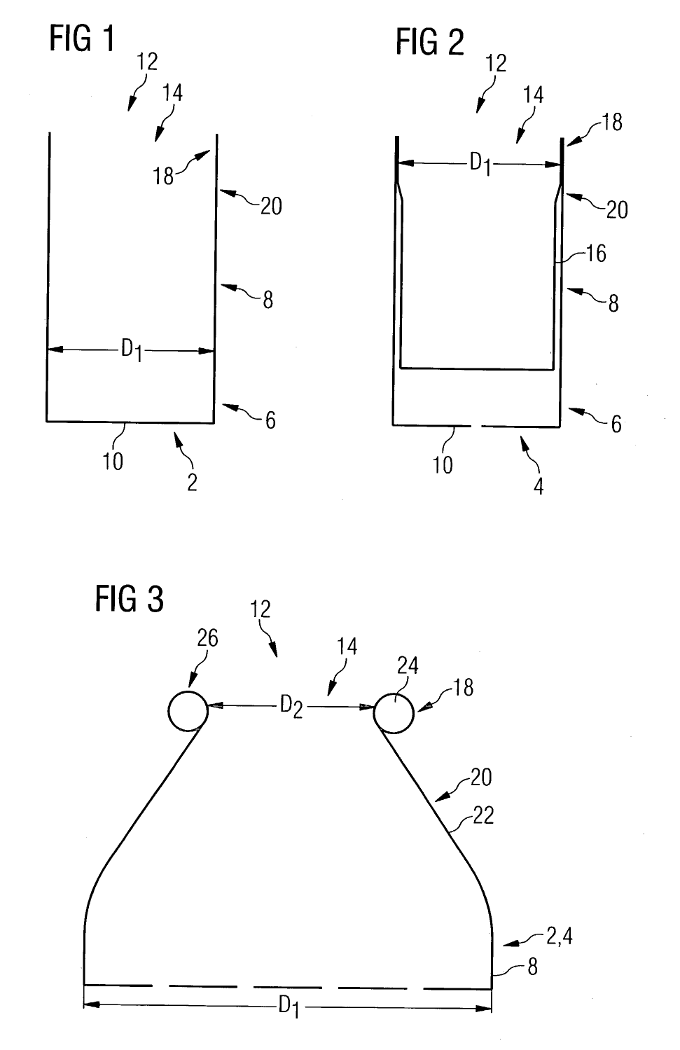

With reference to the FIGS. 1 to 4 a method of producing a pressurized package will now be described in which a flange or bead rimming a mouth aperture of the pressurized package is subsequently coated with a coating material for a satisfactory seal of the dispensing valve. For producing the pressurized package firstly a blank is produced as identified by the reference numeral 2 in a first embodiment and by the reference numeral 4 in a second embodiment.

Referring now to FIG. 1 there is illustrated a pressurized package blank 2 for producing a single-chamber pressurized package whilst with reference to FIG. 2 there is illustrated a pressurized package blank 4 for producing a two-chamber pressurized package. The pressurized package blanks 2 illustrated in FIG. 1 for producing a single-chamber pressurized package comprises an aluminium outer container 6 configured substantially cylindrically, the cylindrical shell 8 of which already features the first diameter D1 determining the later outer diameter of the pressurized package produced thereby. The pressurized package blank 2 is closed off at one end by a bottom 10 and is totally open at the other end 12 forming an aperture 14. The bottom 10 as is usual with pressurized packages is domed inwards, but shown flat in this case for simplicity. The size of the aperture 14 for the pressurized package blank 2, 4 is still first diameter D1. The outer container 6 is made of aluminium. For this purpose it is cold shaped from aluminium round blank (not shown) into the shape as shown in FIG. 1. It is in this shape that the cylindrical shell 8 is provided with the customized design and lined with an inner protective coating.

Referring now to FIG. 2 there is illustrated a pressurized package blank for producing a two-chamber pressurized package, which likewise comprises the outer container 6 as described with reference to FIG. 1. Like parts with those of the first embodiment are identified by like reference numerals. Inserted into the outer container 6 is an inner container 16, also termed pouch, and made of soft-annealed aluminium. At the rim 18 rimming the aperture 14 the inner container 16 and outer container 6 are firmly joined together by an adhesive. Production of the pressurized package blank 4 is done as described in WO 99/20413 to which reference is made in its full extent. Prior to the inner container 16 being inserted and widened it is lined with an inner protective coating.

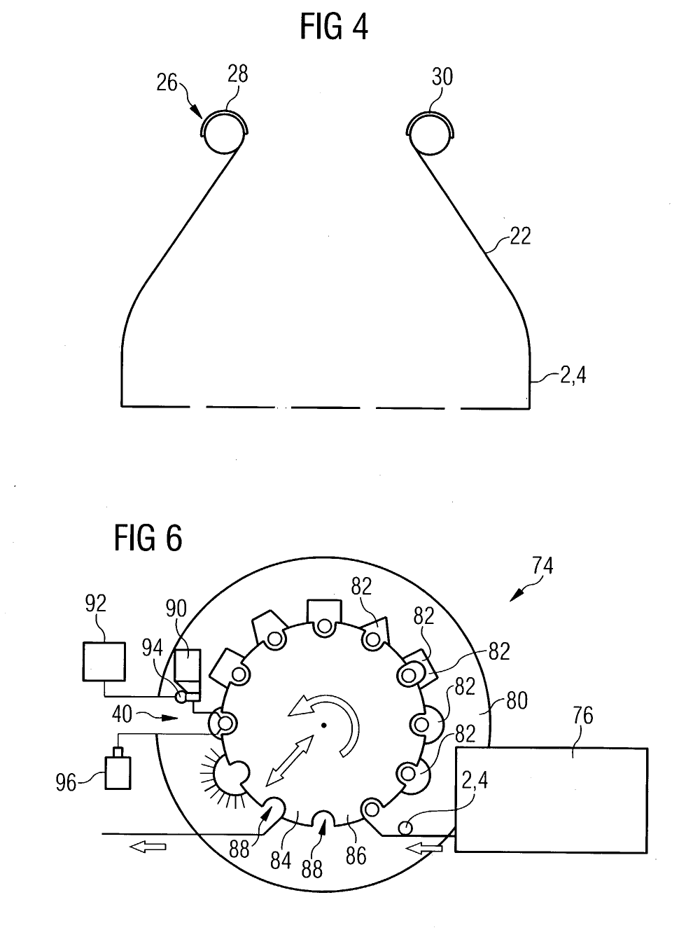

Referring now to FIG. 3 there is illustrated how for production of the pressurized package the rim portion 18 of the pressurized package blanks 2 or 4 are brought into the shape as shown. The portion 20 comprising the rim 18 of the open end 12 of the pressurized package blank 2, 4 is shaped by a necking process into a tapered mouthpiece 22 from the first diameter D1 to a standardized second smaller diameter D2. In this arrangement the rim 18 is turned into a flange or bead 24. In the example as shown in this case the second diameter D2 is one inch, i.e. approx. 25.4 mm, the first diameter D1 being more than 45 mm to form an outer diameter of the pressurized package of approximately 50 mm and more. The aperture 14, now reduced in size, rimmed by the bead 24, is standardized to the diameter D2 for compatibility with usual filling systems and more particularly with dispensing valves, such as aerosol valves (not shown) with which the aperture 14 is closed off following filling of the pressurized package. The pressurized packages formed from the blanks 2, 4 have a tendency at larger first diameter D1 to produce irregularities, especially in the form of dimples and cracks in the surface of the bead. These irregularities occur particularly when various materials are paired in the necked down portion, i.e. mouthpiece 22, rim portion 20 and rim 18, as is the case with the pressurized package blank 4 including the relatively hard outer container 6 of aluminium, the elastomeric adhesive and the soft-annealed aluminium inner container 16. This is why in the method as provided for presently, the cylindrical pressurized package blanks 2, 4 supplied to a necking flanger or beader formed by the necking machine, the same as methods employed hitherto, are necked down step-by-step to the finished bead 24. In a subsequent station the bead 24 is wetted with coating material 28 to seal the portion 26 serving to form a seal with the dispensing valve, as is evident from FIG. 4. Subsequently, the UV radiation curable coating material 28 is cured in a further station by means of radiation source, for example an UV radiation source, near instantly.

In another embodiment (not shown) the bead 24 is previously roughened to achieve a better tack for the coating material, or machined to smooth off larger irregularities before being coated with a protective film 30 of the radiation curable coating material 28.

There are various embodiments for applying the sealing coating material film 30 by spray, roll, dip, brush application; preferably, however, the film 30 is applied by contact with a material wetted with the coating material 28, this applying material being preferably felt, foamed plastics or rubber.

Subsequently coating the bead 24 with coating material is applicable for all shapes thereof and for all diameters Dl of both single-chamber and two-chamber pressurized packages, especially aerosol cans, to smooth out crevices, cracks, dimples, chipped lacquer locations, etc in the portion 26 for sealing.

The UV curable coating material 28 is coated in a very thin film 30 and then cured with the UV radiator, the curing time of the UV curable coating material and its coating film thickness being selected so that the curing time is roughly in the range of half a second. Coating is preferably done in the necking flanger or beader, i.e. for example included in the necking machine. The curing time is set so short so that fast timing in fabrication of more than roughly a 100 items per minute is possible. Instead of an UV curable coating material any other quick curing coating compatible with such timing may be used. As coating material 28, preferably, a coating highly resistant to chemicals and based on acrylates, which polymerise if exposed to UV radiation, is used. The viscosity of the coating material 28 is in the range 15 to 40 s, preferably 25 s, i.e. as the time needed to run from a 4 mm beaker in accordance with the pertinent German DIN Standard.

Referring now to FIG. 5 there is illustrated a coater for applying the coating film 30 to the bead 24, as will now be described. The coater 40 comprises a housing 42, a rotating means 44, a coating material feeder 46, a coating disk 48 rotatatable by means of the rotating means 44 and a draining means 50 for removing excess coating material.

The housing 42 can be secured precisely located by a positioner formed by setscrews (nuts) 52 in a device for producing of a pressurized package, more particularly in the necking flanger thereof. The housing 42 encloses the coating disk 48 almost completely, the space 54 taken up by the coating disk 48 being covered at an end 56 of the housing 42 facing the pressurized packages by a housing cover 58 releasable secured to the base body of the housing. The housing cover 58 comprises a conically tapered centering insertion opening 60 serving to precisely locate the mouthpiece 22 centered.

The rotating means 44 comprises a servomotor 62 controlled to rotate in the range 30-300 rpm as powered and controlled via the wiring 64.

The coating disk 48 comprises a support disc 66 mounted on the spindle of the servomotor 62, an applicator 68 for applying the coating material being secured to the support disc 66. This applicator 68 is made of an elastomeric and/or absorbent material such as sponge or preferably felt. The rotational axis 70 of the servomotor 62 and of the coating disk 48 is arranged horizontally. Located above the coating disk 48 is the coating material feeder 46 which supplies coating material 28 from a lockable dispenser. Provided below the coating disk is the draining means 50 for removing the excess coating material dripping from the coating disk 48.

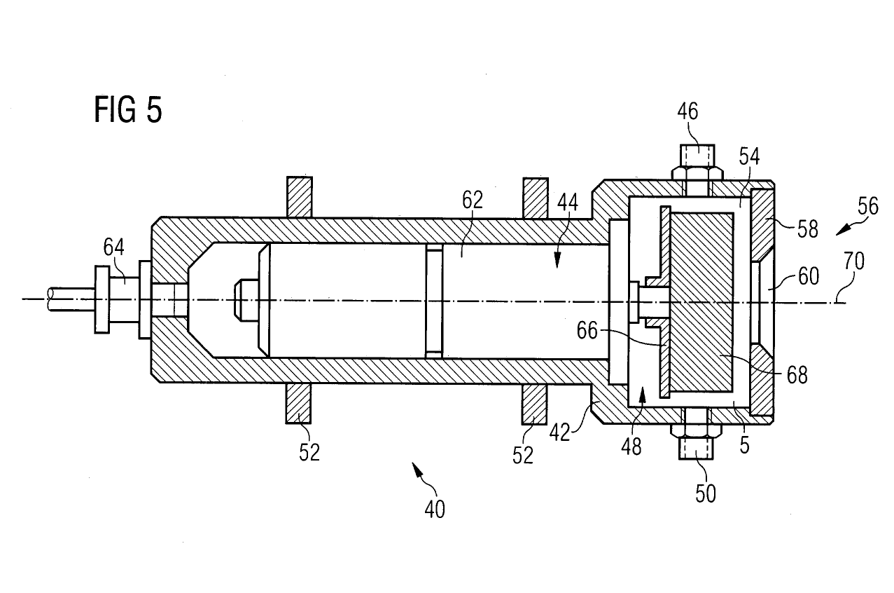

Referring now to FIG. 6 there is illustrated the device for producing the pressurized package and for implementing the method as described above as will now be detailed.

The device 74 for producing the pressurized package comprises a blank providing means 76 for providing or supplying the pressurized package blanks 2 or 4, a necking flanger for necking and flanging or beading the rim 18 of the aperture 14 of the pressurized package blank 2, 4 to the tapered mouthpiece 22, and the coater 40.

The blank providing means 76 is substantially as known from WO 99/20413 and has no special importance to the present description, this being why it is represented merely as a block.

The necking flanger comprises a tool holder 80 in the form of a fixed wheel mounting a train of necking tools 82, each equispaced from the other in a circle. The necking flanger 78 comprises furthermore a holding and conveying means locator 84 for the pressurized package blank 2, 4. The holding and conveying means 84 has the form of a wheel 86 rotatable and axially movable relative to the tool holder 80, the wheel 86 fixedly mounting the pressurized package blanks by its peripheral mounts 88. The wheel 86 of the holding and conveying means 84 rotates spaced away from the tool holder 80 to advance the pressurized package blanks held in the mounts 88 from one tool to the next, it then advancing, without rotating, axial to the tool holder 80 to engage the pressurized package blank 2, 4 with the individual necking tools 82 and then retracting axially from the tool holder 80.

The train of necking/flanger tools 82 is followed by the coater 40 which like a further necking tool is secured to the tool holder 80 and connected to the dispenser 90 which can be shut off by a valve 94 controlled by the controller 92 when the device 74 is halted. Connected to the draining means 50 is a coating material receptacle 96. Provided as a further station following the coater is an UV lamp 98 for curing the coating material 28.

In an embodiment (not shown) the servomotor 62 is also arranged external to the coater 40.

The function of the device 74 in the production of the two-chamber pressurized package as shown in FIG. 2 is such that in the blank providing means 76 the outer container 6 is produced and coated in the way as shown in FIG. 1. By similar ways and means the inner container 16 is produced and coated, subsequently soft annealed before then being opened up by a widening tool and coated with glue. Then, the outer container 6 is placed over the inner container 16 and subsequently the two containers 6, 16 bonded to each other by further widening of the inner container rim. Then, the rims 18 are necked down in the necking flanger 78, for which the train of necking tools 82 is used with which the pressurized package blanks 4 are engaged one after the other. The pressurized package blanks 4 in this arrangement are located in the large wheel 86 which is axially moved to roll in the rim to form the bead by contacting the necking/beading tools. Rotation of the wheel 86 advances the pressurized package blanks 4 to the next necking tool 82. The necking tools 82 are likewise arranged on a (fixed) wheel forming the tool holder 80. The train of necking tools 82 is supplemented at the end by a further tool, the coater 40. This has a felt or similar absorbent material (applicator 68). The applicator 68 is slowly rotated by means of the servomotor 62. The applicator 68 absorbs the coating material 28, whereby the rotation ensures that the coating material remains evenly distributed despite its high viscosity. In other words, even if the device is halted, the coating material does not sink, despite its relative low viscosity, it always being evenly distributed on the applicator 68. The coating material 28 is directed via the valve 94 to the applicator 68. Whenever the system is halted, the valve 94 closes to prevent excessive coating. The axial movement of the wheel 86 causes the flange 24 of the pressurized package blank 4 to “kiss” the applicator 68 so that the flange 24 receives a corresponding film of lacquer 28. The coating film is so thin that the tack of the lacquer 28 causes it to remain evenly distributed on the flange 24 despite the horizontal position of the pressurized package. Immediately thereafter, the coating material wetted bead 24 is advanced to the UV lamp 98 which instantly cures the coating material 28. The now finished pressurized package is then made ready for dispatching to the filler company. Sealing the dispensing valve is then done by the filler company.

What is claimed is:

1. Method for producing a pressure package comprising the steps:
a) providing, more particularly producing, a pressure package blank (2, 4) including a first diameter (D1) and an open end (12) provided with an aperture (14) and
b) forming said open end (12) to a tapered mouthpiece (22) for sealed closure by a pressure valve by necking and flanging or beading said rim (18, 20) of said aperture (14) of said pressure package blank (2, 4), the diameter of said aperture thereby being reduced from said first diameter (D1) to a smaller diameter (D2)
wherein step b) is followed by step
c) coating with a coating material (28) said rim (18) surrounding said aperture (14) formed into a flange or bead (24) at a surface area (26) as predefined for sealing mounting said pressure valve.

2. The method as set forth in claim 1 wherein said bead is coated with a coating material (28) having such a fast curing time and such a thin film that said curing time of said coated film (30) equals or is less than 1 second, preferably approximately half a second or even less.

3. The method as set forth in claim 1 or 2 wherein said coating material lacquer employed is a radiation curing coasting material (28) which after coating said flange (24) is exposed to radiation.

4. The method as set forth in claim 3 wherein an UV curing coating material (28) is employed on the basis of an acrylate resin which polymerise if exposed to UV radiation.

5. The method as set forth in any of the preceding claims wherein a coating material (28) is employed having a viscosity of 15-40 s, preferably approx. 25 s as measured in accordance with German Industry Standard DIN 53211 with a DIN beaker of 4 mm.

6. The method as set forth in any of the preceding claims wherein said coating material (28) is coated with a film thickness in the range of approximately 1 to 10 μm, more particularly 2 to 3 μm.

7. The method as set forth in any of the preceding claims wherein said coating material (28) is coated on said bead (24) by spray, roll, dip, brush application or preferably by contacting said flange (24) with an applying material, more particularly felt, foamed plastics or rubber wetted with coating material.

8. The method as set forth in claim 7 wherein said applying material wetted with coating material and said pressure package contacting the latter are moved relative to each other during contact, more particularly rotated relative to each other.

9. The method as set forth in any of the preceding claims wherein said bead (24) is machined or roughened prior to being coated.

10. The method as set forth in any of the preceding claims wherein in step b) said aperture (14) of said open end (12) is reduced from a first diameter (D1) equal to or larger than 45 mm, more particularly from approximately 50 mm, to a diameter (D2) of approximately 25.4 mm (1 inch).

11. The method as set forth in any of the preceding claims wherein in step a) or b) an inner container (16) is inserted into an outer container (6) of said pressure package blank (4) and joined thereto in the region of said rim (18) of said aperture (14).

12. The method as set forth in claim 11 wherein in step b) said rims of said outer container (6) and said inner container (16) inserted into said outer container (6) joined to each other in the region of said rim (18) of said aperture (14)—preferably by means of an adhesive—are necked and flanged or beaded.

13. A device (74) for fabricating a pressurized package including
a blank providing means (76) for providing said pressurized package blanks (2, 4), having an aperture (14) with a first diameter (D1) at an open end (12),
a necking flanger (78) for necking and flanging or beading said open end (12) of said pressurized package blank (2, 4) to a tapered mouthpiece (22) said device further comprising
a coater (40) for applying coating material to said rim (18) formed to a flange (24) by said necking flanger (78).

14. The device as set forth in claim 13 comprising a radiator, especially an UV lamp (98), for curing a radiation curing coating material (28) applied by said coater (40).

15. The device as set forth in any of the preceding claims wherein said coater (40) comprises an applicator (68) wetted with coating material (28) for contacting said bead (24).

16. The device as set forth in claim 15 wherein said applicator (68) is made of absorbent and/or elastomeric material such as felt or foamed plastics or rubber.

17. The device as set forth in claim 15 or claim 16 comprising a rotating means (44) for rotating said applicator (68) relative to said pressurized packages to be wetted with said coating material (28).

18. The device as set forth in any of the preceding claims wherein said coater (40) comprises a coating material feeder (46), which permits shutting off more particularly by means of a valve (94), for a continual supply of said coating material (28) to said applicator (68).

19. The device as set forth in any of the preceding claims wherein said coater (40) is a component of said necking flanger (78)

20. The device as set forth in any of the preceding claims wherein said necking flanger (78) comprises a tool holder (80) with a train of necking tools (82) for successively necking down and flanging said rim ((18), said tool holder (80) and a holding and conveying means (84) which holds and feeds a train of pressurized package blanks (2, 4) are movable to and from each other in relative movement to engage said necking tools (82) in sequence with each pressurized package blank (2, 4) held and supplied by said holding and conveying means (84), and said coater (40) is held as an additional tool subsequent to said train of necking tools (82) on said tool holder (80).

21. The device as set forth in any of the preceding claims wherein said coater (40) comprises
a housing (42) securable adjustable in position preferably via a positioner (52), more particularly by means of set screws or set nuts and
a coating disk (48) rotatable relative to said housing (42) by means of a servomotor (62) in the speed range 30-300 rpm.

22. The device as set forth in claim 21 wherein said housing (42) clasps at its end (56) facing said pressurized package blank (2, 4) said coating disk (48) at the edge thereof and is provided with a conical tapered centring insertion opening (60) for mounting said mouthpiece (22) to be coated precisely positioned.

23. The device as set forth in claim 21 or 22 wherein said coating disk (48) provided with an absorbent material rotates about a horizontal spindle (70) and above said absorbent material at said coating disk (48) a coating material feeder (46) is provided which feeds coating material (28) from a dispenser (90), and below said absorbent material a draining means (50) is provided to catch excess lacquer (28) dripping from said absorbent material.

24. A pressure package with an aperture to be closed by a pressure packing valve, said aperture being surrounded by a bead on which said valve can be sealingly clamped, said bead being coated after a beading process with a coating material.
